(19) United States
(12) Patent Application Publication
(10) Pub. No.: US 2026/0187955 A1
(43) Pub. Date: Jul. 2, 2026

(54) GENERATION OF MODELS FOR FINE FEATURES

(71) Applicant: GOOGLE LLC, Mountain View, CA (US)

(72) Inventors: David Futschik, San Jose, CA (US); Menglei Chai, Culver City, CA (US); Delio Aleardo Vicini, Zurich (CH); Yinda Zhang, Palo Alto, CA (US)

(21) Appl. No.: 19/429,376

(22) Filed: Dec. 22, 2025

Related U.S. Application Data
(60) Provisional application No. 63/739,041, filed on Dec. 26, 2024.

(51) Int. Cl. G06T 19/20; G06T 17/20

(52) U.S. Cl. CPC G06T 19/20; G06T 17/20; G06T 2219/2024

(57) ABSTRACT

According to at least one implementation, a method includes determining a set of physical characteristics for a set of individuals based on a first model, the first model configured to associate a set of features with a physical characteristic. The method further includes generating a second model based on the set of physical characteristics for the set of individuals and a set of images associated with the set of individuals.

### CROSS-REFERENCE TO RELATED APPLICATION

This application claims the benefit of U.S. Provisional Application No. 63/739,041, filed Dec. 26, 2024, the disclosure of which is incorporated herein by reference in its entirety.

### BACKGROUND

An avatar is a digital representation of a user that serves as their persona in a digital environment. These representations can range from simple two-dimensional (2D) icons or cartoon-like figures to highly detailed, photorealistic three-dimensional (3D) models. An avatar provides a user with a visible presence, allowing them to interact with a virtual space, its objects, and other users. The goal is often to create a digital character that can be customized to resemble the user or an idealized version of them, thereby enabling a more immersive and personal experience.

The use of avatars is critical across numerous technical areas, including media content generation, immersive communication in augmented reality (AR) and virtual reality (VR), and telepresence. In gaming and social VR platforms, avatars facilitate interaction and community. For professional applications, photorealistic avatars can enable remote collaboration and training simulations that feel more personal and engaging. Creating expressive and accurate digital recreations of humans, particularly by capturing fine physical characteristics, is essential for enhancing the realism and effectiveness of these applications, enabling a seamless blend of the physical and digital worlds.

### SUMMARY

The described systems and methods provide a way to create realistic 3D models of complex features, like a hairstyle, for digital avatars. Creating lifelike hair (or other fine features) can be difficult because of the complexity of the details. In some implementations, the approach can start by generating a comprehensive but computationally intensive first model. This first model can be created from a library of different 3D hairstyles and can represent a wide variety of hair shapes using a compact set of parameters. To fit this model to a specific person, a system can run an optimization process, comparing rendered images of the 3D hair to the person's actual photos until a close match is found.

To speed up this process, a second, more efficient machine learning model is created. The system can use the slow first model to analyze images of many different individuals, generating a large dataset of photos paired with their corresponding 3D hair parameters. This dataset is then used to configure the second model. After configuring the second model, the second model can look at a few photos of a new user and directly predict the correct parameters for their hairstyle, bypassing the slow optimization step entirely. This two-stage approach enables the rapid and efficient generation of a personalized, high-quality 3D model of a user avatar.

In some aspects, the techniques described herein relate to a method including: determining a set of characteristics for a set of individuals based on a first model, the first model configured to associate a set of features with a characteristic from the set of characteristics, the characteristic from the set of characteristics being a physical characteristic; and generating a second model based on the set of characteristics for the set of individuals and a set of images associated with the set of individuals.

In some aspects, the techniques described herein relate to a computer-readable storage medium having program instructions stored thereon that, when executed by at least one processor, direct the at least one processor to perform a method, the method including: determining a set of characteristics for a set of individuals based on a first model, the first model configured to associate a set of features with a characteristic from the set of characteristics, the characteristic from the set of characteristics being a physical characteristic; and generating a second model based on the set of characteristics for the set of individuals and a set of images associated with the set of individuals.

In some aspects, the techniques described herein relate to a computing system including: at least one processor; a computer-readable storage medium operatively coupled to the at least one processor; and program instruction stored on the computer-readable storage medium that, when executed by the at least one processor, direct the computing system to perform a method, the method including: obtaining a set of example characteristics; generating a first model based on the set of example characteristics; determining a set of characteristics for a set of individuals based on the first model, the first model configured to associate a set of features with a characteristic from the set of characteristics, the characteristic from the set of characteristics being a physical characteristic; and generating a second model based on the set of characteristics for the set of individuals and a set of images associated with the set of individuals.

The accompanying drawings and the description below outline the details of one or more implementations. Other features will be apparent from the description, drawings, and claims.

### BRIEF DESCRIPTION OF THE DRAWINGS

FIG. 1A illustrates an operational scenario of generating a first model based on a set of example characteristics according to an implementation.

FIG. 1B illustrates an operational scenario of generating a second model based on a first model according to an implementation.

FIG. 2 illustrates a method for generating a model for physical characteristics according to an implementation.

FIG. 3 illustrates an operational scenario of processing images to generate a physical characteristic associated with an individual according to an implementation.

FIG. 4 illustrates an operational scenario for generating a data set according to an implementation.

FIG. 5 illustrates a computing system for generating a model according to an implementation.

### DETAILED DESCRIPTION

The systems and techniques described herein address the technical problem of generating detailed and accurate three-dimensional (3D) models of a person's physical characteristics, such as complex features like hair and facial hair. Creating a realistic digital avatar is important for immersive applications like virtual reality, but capturing the intricate geometry of a person's hairstyle using traditional methods is difficult. Techniques like 3D scanning or photogrammetry often struggle with the fine, complex, and semi-transparent nature of hair, making it a significant challenge to create high-quality digital representations that accurately match a specific individual in a computationally efficient manner.

To overcome these challenges, a two-stage modeling approach can be used to create an accurate 3D surface representation of a user's hair from a set of photographs. An initial, complex model is built using an extensive library of different hairstyles. This first model is precise but can require a slow and resource-intensive optimization process to fit the model to a person's photos. To speed up this process, a second, more efficient machine learning model is configured (i.e., trained) using the results of the first model. By processing photo examples and their corresponding high-quality hair models, this second model learns to directly predict the correct 3D hair shape for a new person, bypassing the need for the slow optimization step.

In computing, an avatar is a digital representation of a user that can be used to interact with a virtual environment. Avatars are used in a variety of applications, including video games, social media, and virtual reality, to provide a sense of presence and identity for the user. They can be created through a variety of methods, such as manual design by an artist, customization from a set of pre-defined options, or generation from user-provided data like photographs or 3D scans.

However, generating realistic avatars from user data presents significant technical challenges, particularly when capturing fine-grained physical characteristics. Features such as hair and facial hair are notoriously difficult to model accurately using conventional techniques like photogrammetry or 3D scanning. The complex geometry, fine strands, and semi-transparent properties of hair can result in incomplete or inaccurate 3D reconstructions. Furthermore, methods that do achieve high detail, such as strand-based representations, can be computationally expensive and resource-intensive, making them difficult to fit to a specific user or render efficiently in real-time applications. These difficulties can result in digital representations that fail to closely resemble the user, thereby diminishing the sense of immersion and presence in virtual environments.

As used herein, a “physical characteristic” (also referred to as “characteristic”) refers to a three-dimensional (3D) surface representation, comprising a collection of vertices, edges, and faces, that defines the geometry of an attribute of an individual, such as the shape and volume of a hairstyle or facial hair. This data structure is the output generated by the first model from a corresponding set of features.

In some technical solutions, a computing system including one or more computing devices can be configured to generate a first model capable of representing a wide range of physical characteristics. This process can begin by obtaining a set of example physical characteristics, which may consist of a large and diverse dataset of digital assets. For instance, when modeling hair, these assets could be a collection of synthetic 3D renderings of potential hairstyles provided by technical artists. These renderings may use various conventional hair representations, such as a strands representation, where individual hair fibers are modeled as curves, or a geometric volumes representation, which models hair as solid 3D shapes for efficient rendering.

As used herein, a “set of example physical characteristics” refers to a collection of digital assets, wherein each asset provides a high-dimensional geometric representation of an instance of a physical attribute, and wherein the collection encompasses a plurality of variations of the physical attribute.

From this dataset of examples, the system can generate a surface representation for the physical characteristic. A surface representation is a 3D surface mesh that captures the geometry of the feature, such as the shape of a hairstyle. To create a consistent and standardized model, the system can register the geometry of each hair asset in the dataset onto a base face model. A base face model is a simplified, neutral 3D mesh of a human face that serves as a common reference, ensuring that all the different hairstyle geometries are aligned within a shared coordinate system. This step effectively converts the varied source data into a unified format suitable for further processing.

The next step involves compressing the surface representation to generate the first model. The detailed surface representations contain a large amount of data (e.g., the coordinates of many vertices), making them computationally complex. To address this, a dimensionality reduction technique such as Principal Component Analysis (PCA) can be employed. PCA analyzes the variations across all the surface representations in the dataset and identifies the principal components—the primary axes along which the shapes differ the most. By projecting the data onto these components, the system can create a more compact representation, effectively compressing the complex geometry into a simplified, low-dimensional form.

This compression process yields a linear model, which serves as the first model. A linear model, in this context, is a mathematical construct that can represent complex hairstyles using a small set of parameters or coefficients rather than the full set of vertex data. This model is configured to associate a set of features (the coefficients) with a specific physical characteristic (the 3D hair shape). The technical effect of using a linear model is a significant reduction in the computational resources required to manipulate and represent the hair geometry. This model can then be used in an optimization framework where, given a set of images of an individual, the system can determine the specific coefficients that generate a 3D hair model most consistent with the person in the photos.

As used herein, a “set of features” refers to a low-dimensional vector of numerical parameters configured to control a generative model, such as the first model. The generative model, in turn, produces a high-dimensional three-dimensional surface representation of a physical characteristic based on the specific values in the vector of numerical parameters.

Once the first model is generated, the computing system can be further configured to generate a second model based on the first. This second model can be designed to serve as a highly efficient machine learning (ML) model that predicts the correct physical characteristics directly from images, thereby avoiding the computationally expensive optimization process of the first model. The generation of this second model begins with the creation of a large-scale training dataset. To assemble this dataset, the system processes a set of individuals, where for each individual, a corresponding set of images is obtained. These images may include multiple views, such as frontal, left, and right profiles, to capture the geometry of the physical characteristic being modeled. For each set of images, the system then applies the first model, using its optimization framework to determine the precise set of features (e.g., the PCA coefficients) that generate a 3D surface representation best matching the individual in the photos. This process results in an extensive collection of paired data: the input images of many different people and the corresponding “ground truth” model parameters that define their specific physical characteristics.

With this comprehensive dataset of image-and-parameter pairs, the system can then train the second model. This model, which may be a deep neural network or another suitable machine learning architecture, is configured to determine the mapping between the visual information present in the input images and the abstract feature set of the first model. During the training or configuration phase, the model is presented with the set of images associated with the set of individuals and tasked with predicting the known set of physical characteristics. The model's internal parameters are iteratively adjusted to minimize the discrepancy between its predictions and the actual feature values generated by the first model's optimization. The objective is to configure the second model to accurately infer the underlying 3D geometry of a feature like hair directly from a few photographs, effectively internalizing the complex logic of the first model's fitting procedure.

The technical effect of this training process is the creation of a predictive model that can bypass the resource-intensive regression or inverse rendering steps. In practice, when a new user provides their images, the second model can analyze the images and directly output the specific set of coefficients for the linear model. These coefficients are then used to reconstruct the final surface representation of the physical characteristic. A physical characteristic, in this context, refers to a specific attribute of an individual, such as the shape and volume of their hairstyle, which is captured by the 3D surface mesh. The first model is the underlying mathematical framework, such as the linear PCA model, that defines the space of all possible shapes for that characteristic using a compact set of features.

The generation of the second model is therefore based on the outputs of the first model applied to a diverse population. By leveraging a set of physical characteristics for a set of individuals as training targets, the second model can be configured to approximate the results of the first model's detailed analysis in a fraction of the time. This makes the system practical for real-time applications, such as live avatar creation in a virtual reality environment. Furthermore, the output of the second model can serve as a superior starting point for the first model's optimization, creating a hybrid approach that can achieve even higher fidelity by significantly accelerating the optimization's convergence. This two-stage approach combines the comprehensive representational power of the first model with the inferential speed of the second, resulting in a system capable of efficiently producing high-quality, personalized 3D models.

For example, to generate the first model for hairstyles, a system can obtain a dataset comprising thousands of diverse 3D hair assets, such as strand-based or geometric volume renderings created by digital artists. Each of these assets can be registered to a common base face model to create a standardized surface representation. A dimensionality reduction technique, such as PCA, can then be applied to this collection of surface representations. The resulting first model is a linear model in which any specific hairstyle can be described by a compact set of features, such as a vector of 100 PCA coefficients, rather than the complete 3D vertex data. This model is highly descriptive but may require a slow optimization process to fit the coefficients to a new user's photos.

In some cases, to fit the model to a specific user, the system can optimize using a set of multi-view images of the user, such as frontal and side profiles. Optimization can be an iterative process in which an initial set of PCA coefficients is used to generate a 3D hair model. This 3D model is then rendered from the same viewpoints as the input photos, and the resulting synthetic images are compared to the user's actual photos. A perceptual error metric can be calculated to quantify the difference, and an optimization algorithm adjusts the PCA coefficients to minimize this error until the generated 3D hair model closely matches the user's appearance in the photographs. For instance, a single PCA coefficient may correspond to a significant global attribute of the hairstyle, such as its overall length or volume. An adjustment to the numerical value of one coefficient could lengthen or shorten the hair strands in the generated model, while a change to another coefficient may alter the perceived thickness or curliness of the hair. The optimization process, therefore, is a search within this low-dimensional coefficient space to find the combination that best recreates the specific hairstyle shown in the photographs.

To generate the second model, a large training dataset can be assembled. For instance, the system may process images from 5,000 different individuals. For each individual, the first model is used in a computationally intensive optimization process to determine the specific vector of 100 PCA coefficients that generates a 3D hair model most consistent with their photos. This creates a dataset of 5,000 pairs, each containing a set of images and its corresponding ground-truth coefficient vector. A machine learning model, such as a neural network, can then be configured (i.e., trained) on this dataset to determine the direct mapping from input images to the output coefficients. Once configured, this second model can take new photos of a user and predict their hair coefficients, enabling rapid generation of a personalized 3D hair model without the slow optimization process.

Although the previous examples describe the generation of models associated with hair, similar processes can be applied to other fine features. For instance, the described two-stage modeling approach can be extended to generate other fine-grained physical characteristics, such as intricate patterns of facial wrinkles and skin pores, as well as detailed features like eyebrows and eyelashes. These features, similar to hair, can be characterized by high-frequency geometric detail that is difficult to capture and represent efficiently with conventional 3D modeling techniques. The principles of creating a comprehensive linear model and then training a predictive machine learning model can be directly applied to these cases, enabling the rapid generation of highly personalized and realistic avatar components.

In this expanded context, a “fine feature” can be technically defined as any physical characteristic whose representation requires capturing either high-frequency geometric variations on a base surface or complex, spatially-varying appearance properties. For geometric features like wrinkles, the physical characteristic can be represented as a displacement map. A displacement map is a data structure, typically a 2D texture, where each pixel's value corresponds to a magnitude by which a vertex on a base 3D mesh should be shifted along its normal vector. This allows for the addition of detailed surface relief without altering the underlying topology of the base mesh, making it a computationally efficient method for representing fine geometric details.

To generate a first model for facial wrinkles, the system can be configured to obtain a set of example physical characteristics, which in this case could be a large dataset of high-resolution 3D scans of individuals of diverse ages and facial structures. From each scan, a displacement map can be extracted by calculating per-vertex positional offsets relative to a standardized, smooth base face model. This process yields a collection of surface representations (i.e., displacement maps) that capture a wide range of natural wrinkle patterns, including crow's feet, forehead lines, and nasolabial folds.

Once this dataset of displacement maps is assembled, the system can perform a compression operation to generate the first model. A dimensionality reduction technique like PCA can be applied to the collection of maps. PCA can identify the principal components of variation across all wrinkle patterns, effectively determining the fundamental building blocks of facial aging and expression lines. The resulting first model can be a linear model in which any complex wrinkle pattern can be synthesized as a linear combination of these principal components, controlled by a compact set of feature coefficients. This model provides a powerful, low-dimensional representation for the vast space of possible facial wrinkles.

With the first model established, a training dataset for the second model can be generated. For each individual in a set of subjects, the system can use the first model within an optimization framework. Given a set of multi-view images of an individual, the optimization process would iteratively adjust the feature coefficients of the linear wrinkle model. For each set of coefficients, a 3D face model with the corresponding wrinkles can be rendered under estimated lighting conditions. By comparing these renderings to the input photos and minimizing a perceptual error metric, the system can determine the precise set of coefficients that best reproduces the appearance of the individual's actual wrinkles.

This process, repeated for thousands of individuals, can create a large-scale dataset pairing multi-view images with their corresponding ground-truth wrinkle coefficients. A machine learning model, such as a deep neural network, can then be configured (i.e., trained) on this dataset. This second model can be configured to determine the direct mapping from the visual cues in a few photographs, such as the subtle shadows and highlights that define wrinkles, to the abstract feature coefficients of the first model.

The technical effect is a highly efficient system for personalizing avatar details. When a new user provides their photos, the trained second model can perform a rapid inference pass to predict the specific coefficients for their unique wrinkle patterns directly. These coefficients are then used by the first model to generate a high-fidelity displacement map, which is applied to the user's avatar to create a realistic and personalized facial appearance. This same methodology could be similarly applied to other features like skin pores, scars, or even the texture and pattern of fabrics for digital clothing.

Ultimately, this two-stage framework provides a generalizable solution to the technical problem of modeling and personalizing a wide range of complex surface details. By separating the comprehensive representational power of a detailed, but slow, first model from the inferential speed of a predictive second model, the system enables the efficient creation of high-quality digital assets. This makes the generation of photorealistic and highly individualized avatars practical for real-time applications and on-device execution, significantly enhancing the sense of presence and realism in virtual environments.

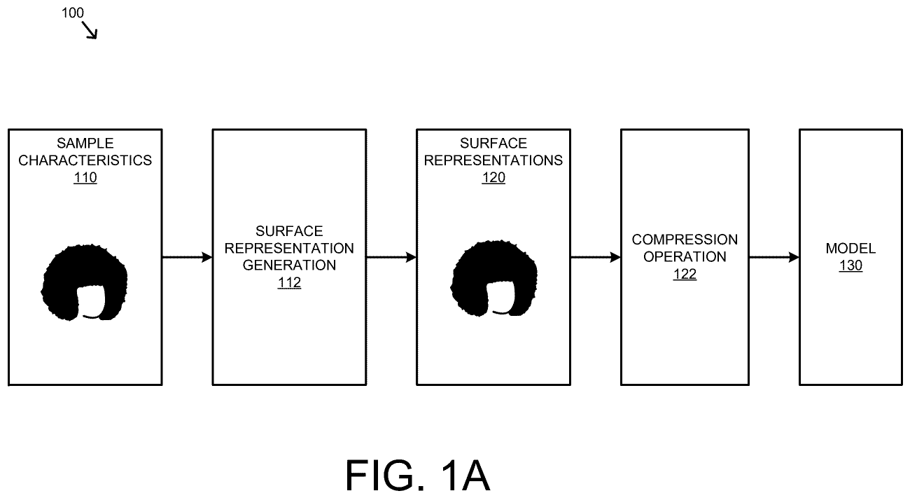

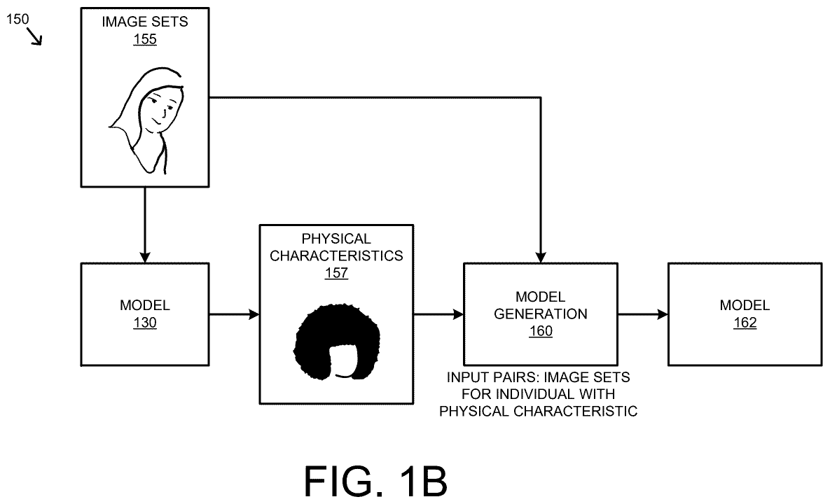

FIG. 1A illustrates an operational scenario 100 of generating a first model based on a set of example characteristics according to an implementation. Operational scenario 100 includes sample characteristics 110, surface representation generation 112, surface representations 120, compression operation 122, and model 130. Surface representation generation 112 processes sample characteristics 110 to generate surface representations 120. Once generated, compression operation 122 can generate model 130 from the surface representations 120. Operational scenario 100 can be performed by one or more computing devices, such as devices that make up a photorealistic avatar generation computing system.

In operational scenario 100, sample characteristics 110 represent the initial dataset of example physical characteristics that serve as the foundation for generating the first model. This dataset can be a large and diverse collection of digital assets designed to capture a wide range of variations for a specific feature, such as different hairstyles or types of facial hair. For instance, to build a model for hair, the sample characteristics 110 may include a large dataset of distinct synthetic hair assets. The purpose of this comprehensive collection is to provide a robust basis from which the system can learn the underlying structure and variability of the physical characteristic to be modeled.

The digital assets comprising the sample characteristics 110 can be provided by technical artists or generated through other means. A common form for these assets is a set of 3D renderings that utilize conventional representations for features like hair. For example, the dataset may include assets that use a strands representation, where individual hair fibers are modeled as curves. This method allows for a high degree of detail and realism. Alternatively, the assets might employ a geometric volumes representation, which models hair as solid 3D shapes or masses. This approach can be more computationally efficient and suitable for real-time applications. By incorporating a diverse set of such renderings, the system can build a model that is capable of representing a wide variety of real-world appearances.

Surface representation generation 112 is a process configured to convert the varied digital assets from the sample characteristics 110 into a standardized and computationally uniform format. This process may involve an algorithm that registers the geometry of each asset in the dataset onto a common reference frame. Specifically, each hair asset, whether it is a strands-based model or a geometric volume, can be algorithmically fitted and aligned to a base face model. A base face model is a neutral, simplified 3D mesh of a human face that serves as a consistent anatomical anchor, ensuring that all hairstyle geometries are positioned and scaled within a shared coordinate system.

The output of this process is the surface representations 120. In this technical context, the surface representations 120 are a set of three-dimensional (3D) surface meshes. A 3D surface mesh is a collection of vertices, edges, and faces that defines the shape of a polyhedral object in 3D computer graphics. Each surface mesh in the set corresponds to one of the input sample characteristics and captures the external shape and volume of that particular hairstyle as a continuous surface. This transformation converts potentially complex or varied data types, like individual hair strands, into a consistent mesh format that is more amenable to geometric analysis and processing.

The technical effect of the surface representation generation 112 is the creation of a structured and aligned dataset. By registering each hairstyle to a common base face model, the system ensures that the resulting surface meshes are directly comparable. This standardization is a critical prerequisite for the subsequent compression operation 122. It allows dimensionality reduction techniques, such as PCA, to effectively identify the primary modes of variation across the different hairstyle shapes, as the differences between meshes will represent genuine geometric variance rather than discrepancies in position, orientation, or scale.

Once surface representations 120 are generated, the computing system can perform a compression operation 122. This compression operation 122 is a process configured to reduce the dimensionality of the data contained within the surface representations 120. Each surface mesh in the set is defined by a large number of vertices, making the collective dataset computationally intensive to process and manipulate directly. The primary objective of the compression operation is to transform this high-dimensional data into a more compact and efficient format without losing the essential geometric information that defines the variations between different hairstyles. This creates a simplified representation that is suitable for use in optimization algorithms.

To achieve this, the compression operation 122 can employ a dimensionality reduction technique. A dimensionality reduction technique is a mathematical procedure used to reduce the number of random variables under consideration by obtaining a set of principal variables. A common implementation of this is PCA. In this context, PCA analyzes the vertex data across the entire collection of surface representations 120 to identify the principal components of variation. These components are orthogonal axes that capture the most significant differences in shape across the dataset, such as variations in length, volume, or curvature. By projecting the original high-dimensional mesh data onto a smaller number of these principal components, the system can create a low-dimensional representation that preserves the most important geometric features.

The output of this compression is model 130, which is a linear model. As used herein, a linear model is a mathematical construct that can generate a specific 3D surface representation through a linear combination of its basis components (e.g., the principal components from PCA). Instead of describing a hairstyle with thousands of vertex coordinates, the linear model can represent it using a small set of features, such as a vector of coefficients. Each coefficient corresponds to one of the principal components, and by adjusting these coefficients, the model can reconstruct any of the original hairstyles or even generate new, plausible variations that lie within the learned shape space.

The technical effect of generating this linear model can be a significant reduction in the computational resources required to represent and fit the hair geometry. The compact set of features makes it feasible to use the model within an optimization framework. Given images of a new individual, an optimization algorithm can efficiently search for the specific set of coefficients that produces a 3D hair model that best matches the person in the photos, a task that would be prohibitively slow if performed on the original, uncompressed surface representations. Model 130 thus serves as the first model, providing a powerful and efficient foundation for creating personalized digital avatars.

For instance, to generate a hair characteristic for a specific individual, the system can be provided with a set of images of the individual, such as photos from frontal, left, and right perspectives. The system can then use model 130 within an optimization framework to determine the set of features that generates a surface representation most consistent with the images. This iterative process may begin with an initial set of coefficients for model 130, which are used to generate a preliminary 3D hair model.

This 3D model can be rendered to create synthetic images corresponding to the viewpoints of the input photos. The system then computes an error metric, such as Learned Perceptual Image Patch Similarity (LPIPS) or a per-pixel difference, by comparing the rendered images to the actual images of the individual. Based on this error, the optimization algorithm iteratively adjusts the coefficients of model 130 to minimize the discrepancy. This cycle of generating a model, rendering it, and adjusting the features continues until the rendered images closely match the input photographs. The final set of coefficients represents the specific physical characteristic of that individual, providing an accurate 3D surface representation of the hair derived from the linear model.

In some implementations, the generation of surface representations 120 from sample characteristics 110 can be a multi-stage process designed to create a computationally uniform dataset from diverse source assets. The sample characteristics 110 may include assets in various formats, such as a strands representation, where individual hair fibers are modeled as parametric curves like splines, or a geometric volumes representation, which models hair as a solid 3D shape using a polygonal mesh. To create a standardized format, the surface representation generation 112 process may first convert these different representations into a consistent 3D surface mesh. For a strand-based asset, this can involve generating an enclosing surface, or a “hull,” that captures the overall volume and shape defined by the curves. For a volume-based asset, the process may involve remeshing to ensure a consistent topology across the dataset. A critical step in this process is geometric registration, where each generated mesh is algorithmically aligned with a base face model. This base face model serves as a canonical anatomical reference, ensuring that all hairstyle meshes are positioned and scaled consistently within a shared coordinate system. The registration may use non-rigid deformation techniques to warp each hairstyle onto the base head, establishing a one-to-one correspondence between vertices across all meshes. The final output is the set of surface representations 120, where each representation is a 3D surface mesh with a common topology, and the variation between them is encoded solely in the 3D coordinates of the vertices. This standardization can be essential for the subsequent compression operation, as it allows for a direct mathematical comparison of the shapes, enabling techniques like PCA to effectively model the geometric variance of the hairstyle

FIG. 1B illustrates an operational scenario 150 of generating a second model based on a first model according to an implementation. Operational scenario 150 includes model 130, image sets 155, physical characteristics 157, model generation 160, and model 162. Operational scenario 150 is a continuation of operational scenario 100 of FIG. 1A. In operational scenario 150, the computing system can use model 130 to process image sets 155 that are associated with different individuals to generate physical characteristics 157 (e.g., hair styles). Once the physical characteristics 157 are determined, model generation 160 can use the pairing of image sets 155 and physical characteristics 157 to generate model 162.

In operational scenario 150, the process of generating the second model 162 begins with obtaining image sets 155, which represent a large-scale dataset containing images of different individuals. For each individual, the dataset may include multiple images captured from various perspectives, such as frontal, left, and right views. This multi-view approach provides the system with comprehensive visual data necessary to accurately infer the three-dimensional geometry of a physical characteristic, such as a particular hairstyle. The diversity of individuals and hairstyles within this dataset can be used for configuring a robust and generalizable second model 162.

For each individual's set of images, the system can use the first model, model 130, in an optimization process to determine the corresponding set of features that generates a physical characteristic. This process, often referred to as inverse rendering or regression, iteratively adjusts the set of features (e.g., PCA coefficients) of the linear model 130 to generate a 3D surface representation that, when rendered, most closely matches the input photographs. The system compares the rendered images to the actual images and calculates an error metric. This error is then used to guide adjustments to the features until the discrepancy is minimized. The final, optimized set of features for an individual is stored in physical characteristics 157, which define their specific physical characteristic.

This optimization can be performed for each individual in image sets 155, resulting in a large collection of paired data: each set of input images is matched with its corresponding ground-truth physical characteristic (the feature vector). This collection of pairs serves as the training dataset for model generation 160.

In some implementations, once physical characteristics 157 are determined, model generation 160 can generate model 162 using image sets 155 and physical characteristics 157. Model generation 160 can be a process configured to train a machine learning model, such as a deep neural network, using the paired dataset. The objective of this configuration process or training is to configure model 162 to determine the intricate mapping between the visual information contained in image sets 155 and the abstract feature vectors of physical characteristics 157. During this training phase, the system repeatedly provides the machine learning model with an image set from the dataset as input. The model then generates a prediction of the corresponding feature vector.

This prediction can then be compared with the known ground-truth feature vector from physical characteristics 157 using a loss function that quantifies the discrepancy between the two. An optimization algorithm, such as gradient descent, then adjusts the internal parameters (e.g., weights and biases) of the machine learning model to minimize this error. This iterative process of prediction, error calculation, and parameter adjustment is performed across the entire training dataset until the model converges to a state where it can accurately infer the correct physical characteristics from a given set of images.

The result of this process is model 162, which is the configured (i.e., trained) machine learning model. Model 162 is configured to function as a highly efficient predictive model that can take a new set of images from a user and directly output the specific set of features associated with the user's physical characteristics. The technical effect is that model 162 can bypass the computationally expensive and time-consuming optimization process of the first model 130. This enables the rapid generation of a personalized 3D surface representation, making the overall system practical for real-time or interactive applications, such as on-device avatar creation.

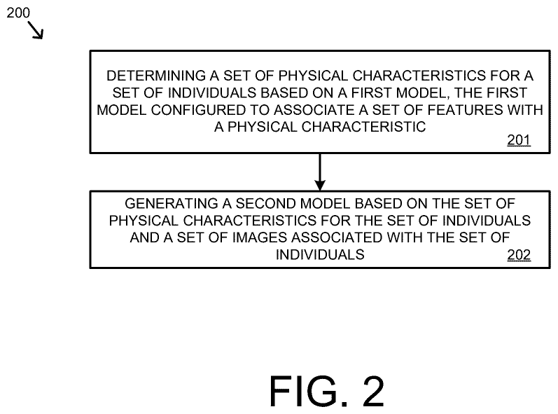

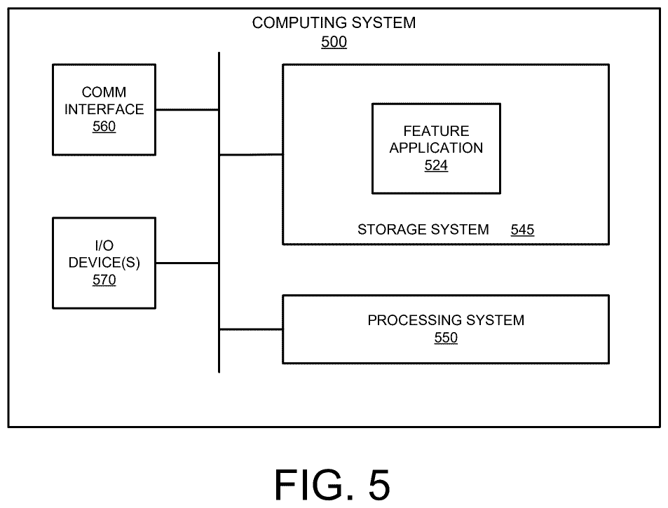

FIG. 2 illustrates method 200 for generating a model for physical characteristics according to an implementation. Method 200 can be implemented on one or more computing devices, such as computing system 500 of FIG. 5.

Method 200 includes determining a set of physical characteristics for a set of individuals based on a first model, the first model configured to associate a set of features with a physical characteristic at step 201. In step 201, the system uses the first model to create a foundational dataset required for training the second model. This can include processing a set of individuals, where for each individual, a corresponding set of images is provided. The first model is then employed in a detailed analysis or optimization process to find the most accurate representation for that person. The output of this optimization process for each individual is a specific set of features. This set of features, for instance, a compact vector of numerical coefficients, is used by the first model to generate a corresponding high-fidelity physical characteristic, such as a 3D surface representation of hair, that precisely matches the individual in the provided images.

The generation of the first model itself is a prerequisite to step 201 and begins with obtaining a set of example physical characteristics. This is a large and diverse collection of digital assets, such as 3D renderings of potential hairstyles, which may be represented as strand-based models or geometric volumes. A strand-based model is a representation where individual hair fibers are modeled as curves, a method that allows for a high degree of detail and realism in styling and animation. In contrast, a geometric volumes model represents hair as solid 3D shapes or masses. This approach is often more computationally efficient for rendering in real-time applications, as it treats hair as clumps with defined surfaces rather than individual strands. From this initial dataset, the system generates a set of surface representations. This is a standardization process where the geometry of each example asset is algorithmically registered, or aligned, onto a common base face model. The technical effect is that all the varied hairstyle examples are converted into a consistent format of 3D surface meshes that are directly comparable.

Once the standardized set of surface representations is created, it is compressed to generate the first model. Each surface mesh in the set can be defined by a high-dimensional vector of vertex coordinates, making direct manipulation computationally expensive. To address this, a dimensionality reduction technique, such as PCA, is applied. PCA analyzes the collection of meshes to identify the primary axes of geometric variation. By projecting the mesh data onto a small number of these axes, the system creates a low-dimensional representation. The first model is the resulting linear model. This mathematical construct can generate a hairstyle within the space through a linear combination of these principal components, controlled by a compact set of features (the PCA coefficients).

With the first model established, step 201 proceeds by applying the first model within an optimization framework to determine the physical characteristic for each individual. For a given set of images associated with an individual, which may include views from different perspectives, the system can perform an iterative fitting process, such as inverse rendering. The process begins with an initial set of features for the first model, generates a corresponding 3D surface, and renders the surface to create synthetic images. These renderings are compared against the actual input images using a perceptual error metric. An optimization algorithm then systematically adjusts the set of features to minimize the calculated error, continuing until the rendered model is most consistent with the photos.

The outcome of performing this optimization for an individual can be a single, precise physical characteristic (the final set of features that best represents the individual). By repeating this process for the set of individuals, step 201 culminates in the creation of a large-scale dataset. This dataset is composed of numerous pairs, each linking a set of images associated with an individual to their corresponding ground-truth set of physical characteristics. This paired data is the input that can be used to train and generate the second model.

Method 200 further includes generating a second model based on the set of physical characteristics for the set of individuals and a set of images associated with the set of individuals at step 202. In step 202, the generation of the second model can be a configuration or training process that leverages the dataset created in the preceding step. The set of physical characteristics determined for the set of individuals serves as ground-truth data, while the corresponding set of images associated with the set of individuals acts as the input data. The objective is to configure a machine learning model that can determine the complex mapping between the visual information in the images and the abstract set of features that define a physical characteristic within the framework of the first model.

The second model may be implemented as a deep neural network or another suitable machine learning architecture. A machine learning model, in this technical context, is a computational system configured to identify patterns within a training dataset and make predictions on new, unseen data. During the generation process, the model is configured to receive, as input, the set of images associated with an individual and to output a prediction of the corresponding set of features for the physical characteristic.

The configuration of the second model can be an iterative process. For each individual in the training dataset, the second model may be provided with the set of images and generate a predicted set of features. This prediction can be compared to the known physical characteristic (the ground-truth set of features from step 201) using a loss function. A loss function is a mathematical function that quantifies the error or discrepancy between the predicted output and the actual target value. An optimization algorithm may then adjust the internal parameters of the second model to minimize this error. This process can be repeated across the entire set of individuals until the model's predictions converge to a desired level of accuracy.

The technical effect of generating the second model is the creation of a highly efficient predictive system. Once configured, the second model can take a new set of images associated with an additional individual and directly infer the set of features for their physical characteristic, bypassing the computationally expensive optimization or inverse rendering process required by the first model. This enables the rapid generation of a personalized 3D surface representation, making the system suitable for resource-constrained environments, such as on-device execution, or for real-time applications where low latency is critical. The output of the second model can then be used to generate the final surface representation of the physical characteristic.

For instance, to determine an additional physical characteristic for an additional individual, the system can use the second model. The additional individual may provide a set of images, such as photographs from frontal, left, and right perspectives. The second model, having been configured based on the large training dataset, can process this set of images and directly output the specific set of features, such as the PCA coefficients, that define the 3D surface of the individual's hairstyle. These features are then used to generate the final surface representation of the physical characteristic, allowing for the rapid creation of a personalized 3D model without needing to perform the time-consuming optimization associated with the first model.

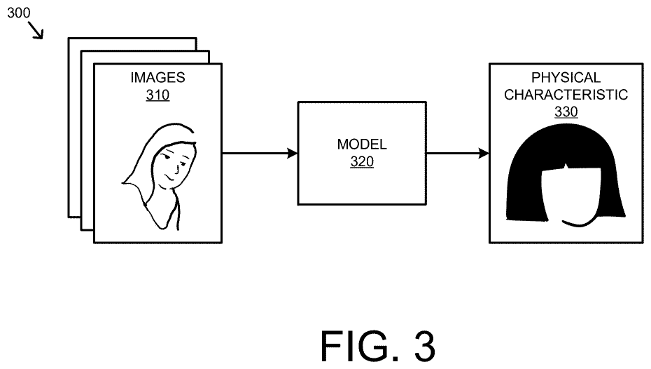

FIG. 3 illustrates an operational scenario 300 of processing images to generate a physical characteristic associated with an individual according to an implementation. Operational scenario 300 includes images 310, model 320, and physical characteristic 330. Operational scenario 300 can be implemented using a computing system, such as computing system 500 of FIG. 5.

In operational scenario 300, a computing system can be configured to generate a physical characteristic for an individual by leveraging a machine learning model. This scenario illustrates the practical application of the second model, referred to here as model 320, which is generated as described in operational scenario 150. The process begins with obtaining a set of images 310 associated with a new individual. These images are then processed by model 320, which is configured to directly infer the appropriate physical characteristic 330. This operational flow represents a computationally efficient pathway for creating personalized 3D models, as it bypasses the resource-intensive optimization framework associated with the first model.

The input to the process, images 310, can be a small set of standard digital photographs of an individual. For example, the set may consist of three Red-Green-Blue (RGB) images capturing the person from different, constrained viewpoints, such as a frontal view, a left profile, and a right profile. These multi-view images provide comprehensive visual data that captures the three-dimensional nature of the physical characteristic being modeled, such as the volume, shape, and style of the person's hair. The images can be acquired using common consumer devices, such as the camera on a smartphone or a wearable device, making the data collection process accessible for end-users in various applications.

Model 320 represents the trained second model, which is a machine learning model, such as a deep neural network, configured to perform direct prediction. This model is configured or trained on a large and diverse dataset, as detailed in operational scenario 150, where each set of training images is paired with a ground-truth physical characteristic determined by the first model's optimization process. As a result, model 320 is configured with a complex, non-linear mapping from the pixel data of input images to the low-dimensional feature space of the first model. The technical effect of using model 320 is a significant reduction in latency and computational cost, enabling the generation of physical characteristics in real-time or near-real-time on resource-constrained hardware.

A physical characteristic is generated for a new individual when the set of images 310 is provided as input to model 320. The model can process the images in a single, feed-forward pass, analyzing visual cues to predict the corresponding set of features. As used herein, a feed-forward pass is a computational process within a configured machine learning model, such as a neural network, where information moves unidirectionally from an input layer, through one or more hidden layers, to an output layer. During this process, the network applies a series of mathematical operations, using its stored weights and activation functions, to transform the input data into the output prediction without any feedback loops. The output of this inference is physical characteristic 330, which is the specific set of features, such as a vector of PCA coefficients, that defines the 3D geometry within the linear model's framework. Once these features are determined, the system can use them with the first model (e.g., model 130) to reconstruct the final, high-fidelity 3D surface representation of the individual's hair or other feature. This process effectively translates a few 2D photos into a detailed 3D geometric model.

For example, a user of an extended reality (XR) device wishing to create a personalized avatar can be prompted by an application to capture three photos of their head using the device's cameras. These images (images 310) are then processed on the XR device by the embedded model 320. The model outputs the specific PCA coefficients (physical characteristic 330) that describe the user's hairstyle. The system then generates a 3D hair mesh from these coefficients and attaches it to the user's base avatar. The result is a realistic digital representation of the user, created quickly and efficiently, which can enhance their sense of immersion and presence in a virtual communication or gaming environment.

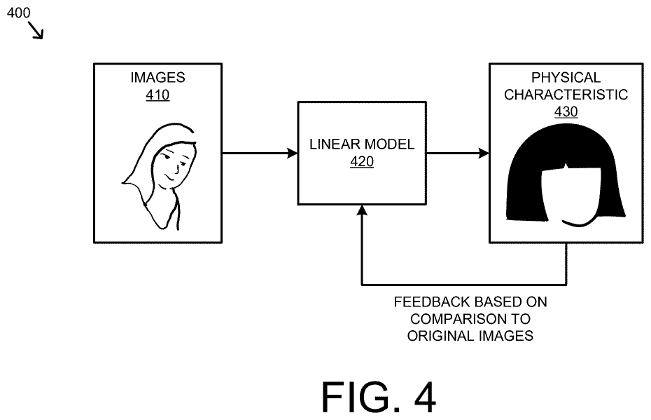

FIG. 4 illustrates an operational scenario 400 for generating a data set according to an implementation. Operational scenario 400 represents the application of a first linear model as described herein. Operational scenario 400 can be implemented on one or more computing devices, such as computing system 500 of FIG. 5. Operational scenario 400 includes images 410, linear model 420, and physical characteristic 430.

In this operational scenario, the computing system is configured to determine a specific physical characteristic 430 for an individual by applying the first model, linear model 420, to a set of input images 410. This process serves as a detailed analysis stage, often referred to as inverse rendering or regression, and is used to generate the high-quality “ground truth” data required for training a subsequent machine learning model. The inputs to this scenario are the images 410, which may consist of multi-view photographs of an individual (e.g., frontal, left, and right profiles), and the linear model 420, which is the compact, low-dimensional representation of a physical feature like hair, as described previously.

The process can be iterative and operate within an optimization framework. In some implementations, the procedure begins with an initial set of features, such as a default or randomly selected vector of coefficients, for the linear model 420. Using these initial features, the system generates a corresponding three-dimensional (3D) surface representation, such as a hair mesh. The system then renders the 3D model to create a set of synthetic 2D images. These synthetic images are generated from the same camera viewpoints as the original input images 410, allowing for a direct comparison between the rendered model and the actual person.

Once the synthetic images are generated, the system can compute an error metric or value by comparing the images to the input images 410. This error quantifies the discrepancy between the current 3D model and the individual's actual appearance. The error metric can be a simple per-pixel difference or a more sophisticated perceptual metric, such as the Learned Perceptual Image Patch Similarity (LPIPS), which is designed to measure differences in a way that aligns more closely with human visual perception. The calculated error value serves as a signal to guide the optimization process.

Based on this error, an optimization algorithm can systematically adjusts the set of features (e.g., the PCA coefficients) of the linear model 420. The goal of the algorithm is to find the specific coefficients that minimize the calculated error. This creates a feedback loop: the system adjusts the features, generates an updated 3D model, renders new synthetic images, and re-computes the error. This cycle continues until the error is minimized and the rendered images closely match the input photographs. The final, optimized set of features is the output, physical characteristic 430. This process, while computationally intensive, produces a highly accurate representation of the individual, which can then be used as a data point in a larger training set.

In some implementations, the process can be repeated with other individuals. By performing this optimization for a set of individuals, the system can generate a comprehensive training dataset. Each entry in this dataset consists of a pair of data: the input images associated with a particular individual and the corresponding ground-truth physical characteristic (the final set of features) determined by the first model. This dataset is then used to configure a second model, which can be a machine learning model such as a deep neural network. The second model can be configured to determine the direct mapping from the visual data in the input images to the feature set of the linear model. During training, the second model is repeatedly provided with image sets and tasked with predicting the known physical characteristics, with its internal parameters being adjusted to minimize prediction errors. The result is a highly efficient model that can infer the correct features for a new user directly, bypassing the need for the iterative optimization process entirely.

Although the previous examples described the functionality using hair, similar operations can be performed in association with other features. For instance, the described two-stage modeling approach can be extended to generate other fine-grained physical characteristics, such as the intricate patterns of facial wrinkles, skin pores, or even detailed features like eyebrows and eyelashes. These features, similar to hair, are characterized by high-frequency geometric detail that is difficult to capture and represent efficiently using conventional 3D modeling techniques. The principles of creating a comprehensive linear model and then training a predictive machine learning model can be directly applied to these cases, enabling the rapid generation of highly personalized and realistic avatar components.

In this expanded context, a “fine feature” can be technically defined as any physical characteristic whose representation requires capturing either high-frequency geometric variations on a base surface or complex, spatially-varying appearance properties. For geometric features like wrinkles, the physical characteristic can be represented as a displacement map. A displacement map is a data structure, typically a 2D texture, where each pixel's value corresponds to a magnitude by which a vertex on a base 3D mesh should be shifted along its normal vector. This allows for the addition of detailed surface relief without altering the underlying topology of the base mesh, making it a computationally efficient method for representing fine geometric details.

To generate a first model for facial wrinkles, the system would begin by obtaining a set of example physical characteristics, which in this case could be a large dataset of high-resolution 3D scans of individuals with diverse ages and facial structures. From each scan, a displacement map can be extracted by calculating the per-vertex positional offsets relative to a standardized, smooth base face model. This process yields a collection of surface representations (the displacement maps) that capture a wide variety of natural wrinkle patterns, such as crow's feet, forehead lines, and nasolabial folds.

Once this dataset of displacement maps is assembled, the system can perform a compression operation to generate the first model. A dimensionality reduction technique like PCA can be applied to the collection of maps. PCA would identify the principal components of variation across all wrinkle patterns, effectively learning the fundamental building blocks of facial aging and expression lines. The resulting first model would be a linear model in which any complex wrinkle pattern can be synthesized as a linear combination of these principal components, controlled by a compact set of feature coefficients. This model provides a powerful, low-dimensional representation for the vast space of possible facial wrinkles.

With the first model established, a training dataset for the second model can be generated. For each individual in a large set of subjects, the system would use the first model within an optimization framework. Given a set of multi-view images of an individual, the optimization process would iteratively adjust the feature coefficients of the linear wrinkle model. For each set of coefficients, a 3D face model with the corresponding wrinkles would be rendered in underestimated lighting conditions. By comparing these renderings to the input photos and minimizing a perceptual error metric, the system can determine the precise set of coefficients that best reproduces the appearance of the individual's actual wrinkles.

This process, repeated for thousands of individuals, can create a large-scale dataset pairing multi-view images with their corresponding ground-truth wrinkle coefficients. A machine learning model, such as a deep neural network, can then be trained on this dataset. This second model can be configured to determine the direct mapping from the visual cues in a few photographs, such as the subtle shadows and highlights that define wrinkles, to the abstract feature coefficients of the first model.

The technical effect is a highly efficient system for personalizing avatar details. When a new user provides their photos, the trained second model can perform a rapid inference pass to directly predict the specific coefficients for their unique wrinkle patterns. The first model then uses these coefficients to generate a high-fidelity displacement map, which is applied to the user's avatar to create a realistic and personalized facial appearance. This same methodology could be similarly applied to other features like skin pores, scars, or even the texture and pattern of fabrics for digital clothing.

Ultimately, this two-stage framework provides a generalizable solution to the technical problem of modeling and personalizing a wide range of complex surface details. By separating the comprehensive representational power of a detailed, but slow, first model from the inferential speed of a predictive second model, the system enables the efficient creation of high-quality digital assets. This makes the generation of photorealistic and highly individualized avatars practical for real-time applications and on-device execution, significantly enhancing the sense of presence and realism in virtual environments.

FIG. 5 illustrates a computing system 500 for generating a model according to an implementation. Computing system 500 represents any computing device or devices with which the various operational architectures, processes, scenarios, and sequences disclosed herein for generating complex features, such as hair. Computing system 500 can include one or more computing devices, such as a server, a cluster of servers, a personal computer, or a mobile device (e.g., a cell phone, wearable device, smart phone, tablet computer, laptop, smart glasses, or another device). Computing system 500 includes storage system 545, processing system 550, communication interface 560, and input/output (I/O) device(s) 570. Processing system 550 is operatively linked to communication interface 560, I/O device(s) 570, and storage system 545. In some implementations, communication interface 560 and/or I/O device(s) 570 may be communicatively linked to storage system 545. Computing system 500 may further include other components, such as a battery and enclosure, that are not shown for clarity.

Communication interface 560 comprises components that communicate over communication links, such as network cards, ports, radio frequency, processing circuitry, software, or some other communication devices. Communication interface 560 may be configured to communicate over metallic, wireless, or optical links. Communication interface 560 may be configured to use Time Division Multiplex (TDM), Internet Protocol (IP), Ethernet, optical networking, wireless protocols, communication signaling, or some other communication format—including combinations thereof. Communication interface 560 may be configured to communicate with external devices, such as servers, user devices, or other computing devices.

I/O device(s) 570 may include computer peripherals that facilitate the interaction between the user and computing system 500. Examples of I/O device(s) 570 may include keyboards, mice, trackpads, monitors, displays, printers, cameras, microphones, external storage devices, sensors, and the like.

Processing system 550 comprises microprocessor circuitry (e.g., at least one processor) and other circuitry that retrieves and executes operating software (i.e., program instructions) from storage system 545. Storage system 545 may include volatile and nonvolatile, removable, and non-removable media implemented in any method or technology for storage of information, such as computer-readable instructions, data structures, program modules, or other data. Storage system 545 may be implemented as a single storage device but may also be implemented across multiple storage devices or sub-systems. Storage system 545 may comprise additional elements, such as a controller to read operating software from the storage systems. Examples of storage media (also referred to as computer-readable storage media) include random access memory, read-only memory, magnetic disks, optical disks, and flash memory, as well as any combination or variation thereof, or any other type of storage media. In some implementations, the storage media may be non-transitory. In some instances, at least a portion of the storage media may be transitory. In no case is the storage media a propagated signal.

Processing system 550 is typically mounted on a circuit board that may also hold the storage system. The operating software of storage system 545 comprises computer programs, firmware, or some other form of machine-readable program instructions. The operating software of storage system 545 comprises feature application 524. The operating software on storage system 545 may further include an operating system, utilities, drivers, network interfaces, applications, or some other type of software. When read and executed by processing system 550 the operating software on storage system 545 directs computing system 500 to operate as a computing system as described herein. In at least one implementation, the operating software can provide the operations described in FIGS. 1-4.

In some implementations, feature application 524 can direct processing system 550 to perform a series of operations to generate and utilize models for creating realistic physical characteristics for digital avatars. This process addresses the technical challenge of efficiently modeling complex features, such as hair, which are difficult to capture accurately with conventional methods. The overall invention can be summarized as a two-stage approach, where a comprehensive but computationally intensive first model is used to create a dataset for training a second, highly efficient predictive model.

First, the system can be directed to generate a first model, which is a foundational linear model capable of representing a wide range of variations for a specific physical characteristic. To do this, the system can obtain a set of example physical characteristics, such as a diverse library of 3D hairstyle renderings. From this library, a set of surface representations is generated by registering each example onto a common base face model, creating a standardized dataset of 3D meshes. This high-dimensional data is then compressed, for example using a dimensionality reduction technique like Principal Component Analysis (PCA), to produce the first model. This model can describe any hairstyle using a compact set of features (e.g., PCA coefficients), but fitting it to a user's photos typically requires a slow optimization process.

Next, the processing system can use this first model to create a large-scale training dataset. This involves determining a set of physical characteristics for a set of individuals. For each individual in a large set, a corresponding set of images, often captured from multiple perspectives, is processed. The first model is used in an optimization framework to iteratively find the specific set of features that generates a 3D model that best matches the person in the photos. Repeating this for many individuals creates a comprehensive dataset linking input images to their corresponding ground-truth feature vectors.

Based on this dataset, the system can then generate a second model. This second model is a machine learning model, such as a deep neural network, that is configured using the paired data of images and their corresponding physical characteristics. During a training phase, the model learns the intricate mapping between the visual information in the images and the abstract feature vectors of the first model. The objective is to configure a model that can approximate the results of the first model's detailed optimization but in a fraction of the time.

The final application of this system leverages the efficiency of the trained second model. To determine an additional physical characteristic for a new user, the system can take as input a new set of images associated with that user. The second model processes these images and directly predicts the corresponding set of features. These features are then used to reconstruct the final 3D surface representation of the physical characteristic. The technical effect is a system that can bypass the computationally expensive optimization step, enabling the rapid and efficient generation of personalized, high-fidelity 3D models for avatars, suitable for real-time or on-device applications.

As an example of the application in practice, a user of an extended reality (XR) device, such as a virtual reality headset or smart glasses, may initiate an avatar creation sequence within an application. The application can direct the user to capture a set of images of their head using the built-in cameras of the XR device. For instance, the user may be prompted to take three standard Red-Green-Blue (RGB) photographs from constrained viewpoints: one from a frontal perspective, one from the left, and one from the right. These images can serve as the input to the trained second model.

Once the images are captured, the second model, which is configured for efficient execution on the XR device's processing hardware, can analyze the set of images in a single feed-forward pass. The model can directly predict the set of features, such as the specific vector of PCA coefficients, that corresponds to the user's hairstyle. These features are then used within the framework of the first model to generate the final 3D surface representation of the hair. This 3D hair mesh is then programmatically attached to the user's base avatar model, resulting in a personalized digital representation that accurately reflects the user's appearance. The entire process allows for the rapid creation of a high-fidelity avatar, enhancing the user's sense of presence and immersion in the virtual environment.

The primary technical effect of generating the second model is the creation of a highly efficient predictive system that can bypass the computationally expensive and time-consuming optimization process associated with the first model. While the first model's regression framework can produce high-fidelity results, the iterative nature of the optimization, which involves repeatedly rendering a 3D model and comparing it to input images, can be too resource-intensive for real-time or on-device applications. The second model, having been trained on the outputs of this process, can approximate the results in a single, rapid feed-forward pass. This reduction in latency and computational load makes the generation of personalized, high-quality 3D surface representations practical for consumer hardware, such as mobile phones or XR devices. Furthermore, the output of the second model can optionally be used as a high-quality initialization for the first model's optimization, creating a hybrid approach that can accelerate convergence and achieve an even tighter fit.

Below are example clauses associated with the present disclosure. The described clauses should not be considered exhaustive.

Clause 1. A method comprising: determining a set of characteristics for a set of individuals based on a first model, the first model configured to associate a set of features with a characteristic from the set of characteristics, the characteristic from the set of characteristics being a physical characteristic; and generating a second model based on the set of characteristics for the set of individuals and a set of images associated with the set of individuals.

Clause 2. The method of clause 1 further comprising: obtaining a set of example characteristics; and generating the first model based on the set of example characteristics.

Clause 3. The method of clause 2, wherein generating the first model based on the set of example characteristics comprises: generating a set of surface representations based on the set of example characteristics; and compressing the set of surface representations to generate the first model.

Clause 4. The method of clause 2, wherein the set of example characteristics comprises 3D renderings of potential hairstyles, and wherein the first model comprises a linear model.

Clause 5. The method of clause 1 further comprising: determining an additional characteristic for an additional individual based on the second model.

Clause 6. The method of clause 5 further comprising: identifying at least one image for the additional individual, wherein determining the additional characteristic is further based on the at least one image.

Clause 7. The method of clause 1, wherein the first model comprises a linear model.

Clause 8. The method of clause 1, wherein the set of images associated with an individual in the set of individuals comprises two or more images from different perspectives for the individual.

Clause 9. A computer-readable storage medium having program instructions stored thereon that, when executed by at least one processor, direct the at least one processor to perform a method, the method comprising: determining a set of characteristics for a set of individuals based on a first model, the first model configured to associate a set of features with a characteristic from the set of characteristics, the characteristic from the set of characteristics being a physical characteristic; and generating a second model based on the set of characteristics for the set of individuals and a set of images associated with the set of individuals.

Clause 10. The computer-readable storage medium of clause 9, wherein the method further comprises: obtaining a set of example characteristics; and generating the first model based on the set of example characteristics.

Clause 11. The computer-readable storage medium of clause 10, wherein generating the first model based on the set of example characteristics comprises: generating a set of surface representations based on the set of example characteristics; and compressing the set of surface representations to generate the first model.

Clause 12. The computer-readable storage medium of clause 10, wherein the set of example characteristics comprises 3D renderings of potential hairstyles, and wherein the first model comprises a linear model.

Clause 13. The computer-readable storage medium of clause 9, wherein the method further comprises: determining an additional characteristic for an additional individual based on the second model.

Clause 14. The computer-readable storage medium of clause 13, wherein the method further comprises: identifying at least one image for the additional individual, wherein determining the additional characteristic is further based on the at least one image.

Clause 15. The computer-readable storage medium of clause 9, wherein the first model comprises a linear model.

Clause 16. The computer-readable storage medium of clause 9, wherein the set of images associated with an individual in the set of individuals comprises two or more images from different perspectives for the individual.

Clause 17. A computing system comprising: at least one processor; a computer-readable storage medium operatively coupled to the at least one processor; and program instruction stored on the computer-readable storage medium that, when executed by the at least one processor, direct the computing system to perform a method, the method comprising: obtaining a set of example characteristics; generating a first model based on the set of example characteristics; determining a set of characteristics for a set of individuals based on the first model, the first model configured to associate a set of features with a characteristic from the set of characteristics, the characteristic from the set of characteristics being a physical characteristic; and generating a second model based on the set of characteristics for the set of individuals and a set of images associated with the set of individuals.

Clause 18. The computing system of clause 17, wherein generating the first model based on the set of example characteristics comprises: generating a set of surface representations based on the set of example characteristics; and compressing the set of surface representations to generate the first model.

Clause 19. The computing system of clause 17, wherein the set of example characteristics comprises 3D renderings of potential hairstyles, and wherein the first model comprises a linear model.

Clause 20. The computing system of clause 17 further comprising: determining an additional characteristic for an additional individual based on the second model.

In accordance with aspects of the disclosure, implementations of various techniques and methods described herein may be implemented in digital electronic circuitry, or in computer hardware, firmware, software, or in combinations of them. Implementations may be implemented as a computer program product (e.g., a computer program tangibly embodied in an information carrier, a machine-readable storage device, a computer-readable medium, a tangible computer-readable medium), for processing by, or to control the operation of, data processing apparatus (e.g., a programmable processor, a computer, or multiple computers). In some implementations, a tangible computer-readable storage medium may be configured to store instructions that when executed cause a processor to perform a process. A computer program, such as the computer program(s) described above, may be written in any form of programming language, including compiled or interpreted languages, and may be deployed in any form, including as a standalone program or as a module, component, subroutine, or other unit suitable for use in a computing environment. A computer program may be deployed to be processed on one computer or on multiple computers at one site or distributed across multiple sites and interconnected by a communication network.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the implementations. They have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

It will be understood that, in the foregoing description, when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application, if any, may be amended to recite exemplary relationships described in the specification or shown in the figures.

As used in this specification, a singular form may, unless definitively indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. In some implementations, the relative terms above and below can, respectively, include vertically above and vertically below. In some implementations, the term adjacent can include laterally adjacent to or horizontally adjacent to.

What is claimed is:

1. A method comprising:
determining a set of characteristics for a set of individuals based on a first model, the first model configured to associate a set of features with a characteristic from the set of characteristics, the characteristic from the set of characteristics being a physical characteristic; and
generating a second model based on the set of characteristics for the set of individuals and a set of images associated with the set of individuals.

2. The method of claim 1 further comprising:
obtaining a set of example characteristics; and
generating the first model based on the set of example characteristics.

3. The method of claim 2, wherein generating the first model based on the set of example characteristics comprises:
generating a set of surface representations based on the set of example characteristics; and
compressing the set of surface representations to generate the first model.

4. The method of claim 2, wherein the set of example characteristics comprises 3D renderings of potential hairstyles, and wherein the first model comprises a linear model.

5. The method of claim 1 further comprising:
determining an additional characteristic for an additional individual based on the second model.

6. The method of claim 5 further comprising:
identifying at least one image for the additional individual,
wherein determining the additional characteristic is further based on the at least one image.

7. The method of claim 1, wherein the first model comprises a linear model.

8. The method of claim 1, wherein the set of images associated with an individual in the set of individuals comprises two or more images from different perspectives for the individual.

9. A computer-readable storage medium having program instructions stored thereon that, when executed by at least one processor, direct the at least one processor to perform a method, the method comprising:
determining a set of characteristics for a set of individuals based on a first model, the first model configured to associate a set of features with a characteristic from the set of characteristics, the characteristic from the set of characteristics being a physical characteristic; and
generating a second model based on the set of characteristics for the set of individuals and a set of images associated with the set of individuals.

10. The computer-readable storage medium of claim 9, wherein the method further comprises:
obtaining a set of example characteristics; and
generating the first model based on the set of example characteristics.

11. The computer-readable storage medium of claim 10, wherein generating the first model based on the set of example characteristics comprises:
generating a set of surface representations based on the set of example characteristics; and
compressing the set of surface representations to generate the first model.

12. The computer-readable storage medium of claim 10, wherein the set of example characteristics comprises 3D renderings of potential hairstyles, and wherein the first model comprises a linear model.

13. The computer-readable storage medium of claim 9, wherein the method further comprises:
determining an additional characteristic for an additional individual based on the second model.

14. The computer-readable storage medium of claim 13, wherein the method further comprises:
identifying at least one image for the additional individual,
wherein determining the additional characteristic is further based on the at least one image.

15. The computer-readable storage medium of claim 9, wherein the first model comprises a linear model.

16. The computer-readable storage medium of claim 9, wherein the set of images associated with an individual in the set of individuals comprises two or more images from different perspectives for the individual.

17. A computing system comprising:
at least one processor;
a computer-readable storage medium operatively coupled to the at least one processor; and
program instruction stored on the computer-readable storage medium that, when executed by the at least one processor, direct the computing system to perform a method, the method comprising:
obtaining a set of example characteristics;
generating a first model based on the set of example characteristics;
determining a set of characteristics for a set of individuals based on the first model, the first model configured to associate a set of features with a characteristic from the set of characteristics, the characteristic from the set of characteristics being a physical characteristic; and
generating a second model based on the set of characteristics for the set of individuals and a set of images associated with the set of individuals.

18. The computing system of claim 17, wherein generating the first model based on the set of example characteristics comprises:
generating a set of surface representations based on the set of example characteristics; and
compressing the set of surface representations to generate the first model.

19. The computing system of claim 17, wherein the set of example characteristics comprises 3D renderings of potential hairstyles, and wherein the first model comprises a linear model.

20. The computing system of claim 17 further comprising:
determining an additional characteristic for an additional individual based on the second model.
